(19) United States
(12) Patent Application Publication
(10) Pub. No.: US 2026/0058384 A1
(43) Pub. Date: Feb. 26, 2026

(54) CONNECTOR ASSEMBLY AND SYSTEM FOR INSTALLING A PRINTED CIRCUIT BOARD OF A CIRCUIT BREAKER

(71) Applicant: HARTING Electronics GmbH, Espelkamp (DE)

(72) Inventors: Rainer BUSSMANN, Bad Essen (DE); Marc GENAU, Luebbecke (DE)

(21) Appl. No.: 19/104,057

(22) PCT Filed: Aug. 25, 2023
(86) PCT No.: PCT/DE2023/100617

§ 371 Date: Feb. 14, 2025

(30) Foreign Application Priority Data
Sep. 9, 2022 (DE) 10 2022 123 031.7

(51) Int. Cl. H01R 12/71

(52) U.S. Cl. CPC H01R 12/712

(57) ABSTRACT

The aim of the disclosure is to electrically connect and secure a circuit breaker to a printed circuit board in a simple and comfortable manner. For this purpose, a connector assembly is proposed having two angled pin contacts, each of which has a plug region with at least four plug segments facing the plug-in direction.

### BACKGROUND OF THE INVENTION

The invention is based on a connector assembly for installing a printed circuit board.

Furthermore, the invention is based on a system comprising a connector assembly according to claim 1, a printed circuit board and a circuit breaker.

Such connector assemblies and systems are required to attach a circuit breaker to a printed circuit board and to connect it electrically conductively to a circuit of the printed circuit board. This makes it possible to either close the circuit in question or to interrupt it if necessary. Such circuits can be designed for high-current applications, i.e., for high currents of more than 16 A (“amperes”), that is to say e.g., at least 24 A, for example at least 32 A, in particular at least 48 A, preferably at least 56 A, particularly preferably even 64 A and more, e.g., also for currents of 70 A and more or even 76 A and more, e.g., even 82 A and more.

Publication EP 3 794 684 A1 discloses a printed circuit board plug connector which is used to electrically connect an electrical cable to a printed circuit board in order to transmit high currents from the cable to the printed circuit board.

WO 2012/000807 A1 shows a bus-compatible connection system for various modules, e.g., a contactor that can be installed on a printed circuit board. For this purpose, a holding element is disclosed which has a frame or, for mounting said contactor, a block cover which has a larger grid than the frame.

A disadvantage of the prior art is the great effort required to install such a circuit breaker on a printed circuit board and to connect it electrically conductively to a circuit, in particular to a high-current circuit, of the printed circuit board.

The German Patent and Trade Mark Office has searched the following documents for the priority application: DE 198 34 478 A1, DE 10 2020 203560 A1, DE 20 2017 107 133 U1, EP 3 794 684 A1 and WO 2012/000807 A1.

### SUMMARY OF THE INVENTION

The purpose of the invention is to provide a connector assembly which is easy to handle and simple to manufacture and has the highest possible current-carrying capacity, with which it is possible to fasten a circuit breaker to a printed circuit board and to connect it electrically conductively to a circuit of the printed circuit board in order to either close or interrupt this circuit.

A connector assembly is used for installing a printed circuit board of a circuit breaker and has at least the following:
at least two pin contacts angled by a connection angle, wherein each of the pin contacts is formed in one piece from metal and has at least the following:
a terminal-side terminal region for electrically conductive connection to the circuit breaker,
a plug-in-side plug-in region for plugging into a through-contact opening of a printed circuit board, wherein the plug-in region has the following:
   a circular cross-section,
   a plug-in axis running in the plug-in direction and
   at least two slots crossing each other in the plug-in axis, whereby
   at least four plug-in segments, each with a circular-segment-like outer contour, are formed in the plug-in region of the respective pin contact, and
a connection portion that connects the plug-in region to the terminal region and is angled by the connection angle.

A system consists of a connector assembly of the aforementioned type and a printed circuit board as well as a circuit breaker, in particular in the form of a circuit breaker and/or residual current circuit breaker, wherein the printed circuit board has a circuit. The circuit has at least one conductor track and is electrically conductively connected to at least two through-contact openings of the printed circuit board. The through-contact opening consists of a circular through-opening of the printed circuit board, in which electrical contact material is applied on the inside and belongs to at least one conductor track or is electrically conductively connected to at least one conductor track. The circuit breaker has a mechanical disconnector/switch with at least two terminals that can be selectively electrically disconnected or electrically connected by the disconnector/switch. One of the angled pin contacts is electrically conductively connected or at least connectable to each of these two terminals on the terminal side. On the plug-in side, the respective pin contact is plugged or can be plugged into said through-contact opening and is thus electrically conductively connected or at least connectable to the circuit for connecting the circuit breaker to the circuit.

A particular advantage of the invention is that each pin contact can be plugged with its plug-in region directly into corresponding through-contact openings of the printed circuit board and can thus be electrically contacted with the contact material of the corresponding conductor track of the circuit of the printed circuit board located therein. The circular segment-like outer contour of the plug-in segments enables a large-area electrical connection between the pin contact on the one hand and the contact material with which the inner surface of the through-hole (“through-contact opening”) of the printed circuit board is coated, and thus also a particularly current-conductable electrical connection with the electrically conductive circuit of the printed circuit board connected to it.

As the printed circuit board connector has at least two slots that intersect in its plug-in axis, it can provide the elasticity required for the plug-in connection. In particular, the resulting plug-in segments can move at least slightly towards each other when plugged in, applying a corresponding counterforce.

The pin contact can have symmetry at least in its plug-in region and can, at least in this region, be rotationally symmetrical and/or mirror-symmetrical, in particular axially symmetrical. Preferably, the plug-in axis can simultaneously be a pin axis and thus an axis of symmetry of the pin contact or at least of a portion, namely the plug-in region, of the pin contact.

Advantageously, when plugged in, the pin contact can protrude with its plug-in end through the through-contact opening of the printed circuit board and thereby make electrically conductive contact with the contact material of the printed circuit board arranged in the through-contact opening and thus be electrically conductively connected to said circuit for high-current transmission. It is of particular advantage that at least four, in particular identical, plug-in segments of the printed circuit board connector pointing in the plug-in direction are formed in the plug-in region. These plug-in segments can be moved at least slightly towards each other by at least slight elastic deformation of the plug-in region, for example by pressing the plug-in segments together. Due to its at least one slot and its elasticity, in particular its at least slightly reversibly deformable material, in particular metal, the plug-in region ultimately has the at least slight deformability required for this.

During the plugging process, the plug-in segments can move towards each other, with their outer surfaces ideally aligned parallel to the plug-in direction and, with the application of a corresponding outwardly acting counterforce, make electrically conductive contact with a contact material arranged in the through-contact opening of the printed circuit board, also viewed in the plug-in direction, with the largest possible common contact surface, ideally in parallel alignment. The contact material preferably belongs to a conductor track of the circuit of the printed circuit board, i.e., it is at least electrically conductively connected to the respective conductor track.

It is particularly advantageous here that the circuit breaker can already be fastened to the printed circuit board by inserting the plug-in region of the pin contacts into the through-contact openings of the printed circuit board.

In a preferred embodiment, the connection angle is greater than 85° and less than 95°. In particular, the idealized connection angle can be a right angle. This is particularly advantageous because it means that commercially available circuit breakers can be used. These usually have two electrical terminals each, which are located on opposite sides of a housing of the respective circuit breaker. In this way, both terminals can be connected to the printed circuit board with the least possible effort.

In a preferred embodiment, the slots can end either in the plug-in region or at the latest in the connection portion, preferably in any case on the plug-in side of the connection angle.

Furthermore, each pin contact can be formed from a metallic material that is at least slightly reversibly deformable. The pin contact may be a turned part, at least in portions. The slots can be cut into the plug-in region by sawing or milling.

The plug-in region can be symmetrical. The pin axis can be an axis of symmetry of the plug-in region, at least in some regions.

In a preferred embodiment, the diameter of the plug-in region increases at least slightly towards the plug-in-side end of the pin contact in the unplugged state. This has the advantage that the outer surfaces of the plug-in segments are aligned parallel in the plugged state under the application of a counterforce, which is directed outwards by the deformation and which acts as a pressure force and thus as a contact force. In addition to the positive effect of the circular segment-like outer contour, this also has the further positive effect that the size of the contact surface between the pin contact and the through-contact opening is also optimized, i.e., maximized, in the plug-in direction. In this way, the largest possible joint contact area is achieved between the pin contact and the through-contact opening while at the same time applying the necessary contact pressure.

In a further advantageous embodiment, the connection portion is surrounded by an electrically insulating material, at least in the region of the connection angle. On the one hand, this is advantageous because the contact pin is thus protected against contact and can be safely touched by hand at the insulating material. On the other hand, the insulating material can also be formed by a contact carrier, which surrounds the respective connection contact in the region of its connection angle.

Such a contact carrier can also have a latching device for additional fastening/improving of the fastening of the pin contact to the printed circuit board. This is particularly advantageous because it also allows a particularly large and heavy circuit breaker to be fastened to the printed circuit board by holding it on both sides of the two pin contacts on the printed circuit board. This means that the connector assembly can be latched to and released from the printed circuit board by simple means and manually in a straightforward and self-explanatory manner, which has the advantage that the circuit breaker can also be latched to the printed circuit board and released again just as easily. The latching device can, for example, take the form of one or more latching arms, each with a latching hook at the end.

### BRIEF DESCRIPTION OF THE DRAWINGS

An exemplary embodiment of the invention is shown in the drawings and is explained in greater detail below. In the drawings:

FIG. 1a shows a pin contact according to the prior art;

FIG. 1b shows a printed circuit board according to the prior art;

FIG. 1c shows a contact carrier with latching arms according to the prior art;

FIG. 1d shows an assembly of the aforementioned components;

FIGS. 2a, b show an angled pin contact without and with a plastics casing;

FIGS. 3a, b show a circuit breaker with two angled pin contacts to be connected to it or connected to it;

FIG. 4 shows a printed circuit board and a circuit breaker fastened to it via the two angled pin contacts by means of one insulator each.

### DETAILED DESCRIPTION OF THE INVENTION

Some of the figures contain simplified, schematic representations. In some cases, like reference signs are used for like but possibly not identical elements. Different views of the same elements may be scaled differently. Directional indications such as “left”, “right”, “top” and “bottom” are to be understood with reference to the respective figure and may vary in the individual illustrations in relation to the object shown.

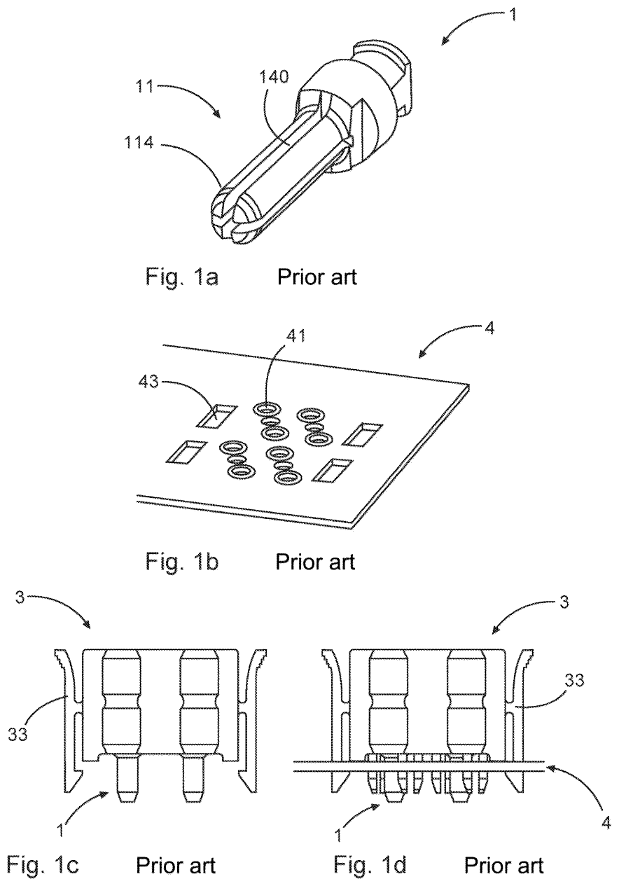

FIG. 1a shows a pin contact 1 corresponding to the prior art. This has a plug-in region 11, which is divided into four plug-in segments 114 pointing in the plug-in direction by two slots 140 intersecting at right angles in a plug-in axis not shown. The plug-in axis is not shown for reasons of clarity, but is apparent to a person skilled in the art from the symmetry of the plug-in region 11 on the basis of the above.

FIG. 1b shows a printed circuit board 4 with through-contact openings 41 and latching recesses 43. The through-contact openings 41 are each provided with an electrically conductive inner coating made of electrically conductive contact material.

FIG. 1c shows a contact carrier 3 with latching arms 33. Two pin contacts 1 are accommodated in the contact carrier 3.

FIG. 1d shows an assembly known from the prior art consisting of the aforementioned components, namely the two pin contacts 1, the printed circuit board 4 and the contact carrier 3 latched to the latching recesses 43 of the printed circuit board 4 by means of its latching arms 33.

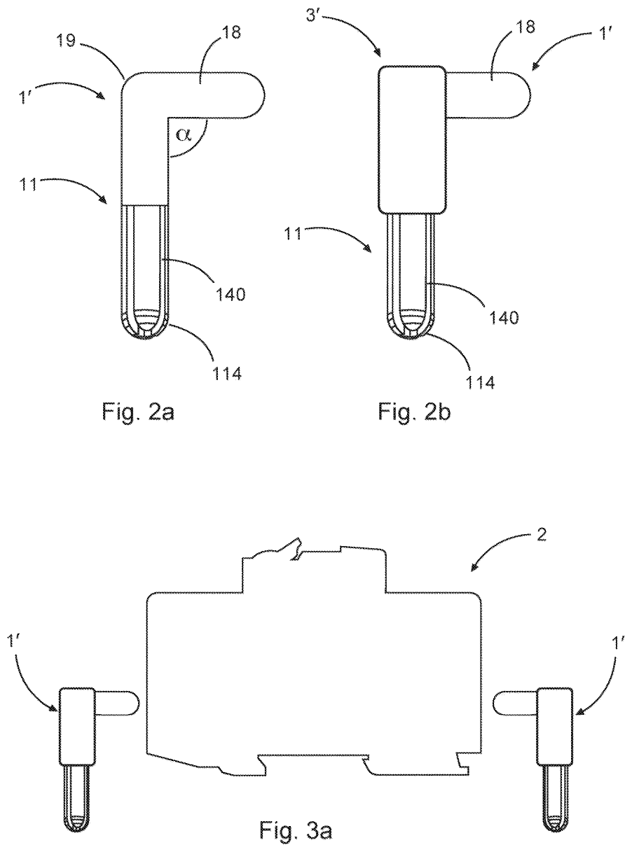

FIG. 2a shows a one-piece, angled pin contact 1′. This has a terminal region 18 and a plug-in region 11, which are connected to each other via an angled connection portion 19 of the pin contact 1′. The plug-in region 11 is divided into four plug-in segments 114 pointing in the plug-in direction by two slots 140 intersecting at right angles in a plug-in axis not shown.

FIG. 2b shows the angled pin contact 1′ with a casing 3′, which surrounds the pin contact 1′ in the region of its connection portion 19. The casing 3′ is made of plastic or another electrically insulating material.

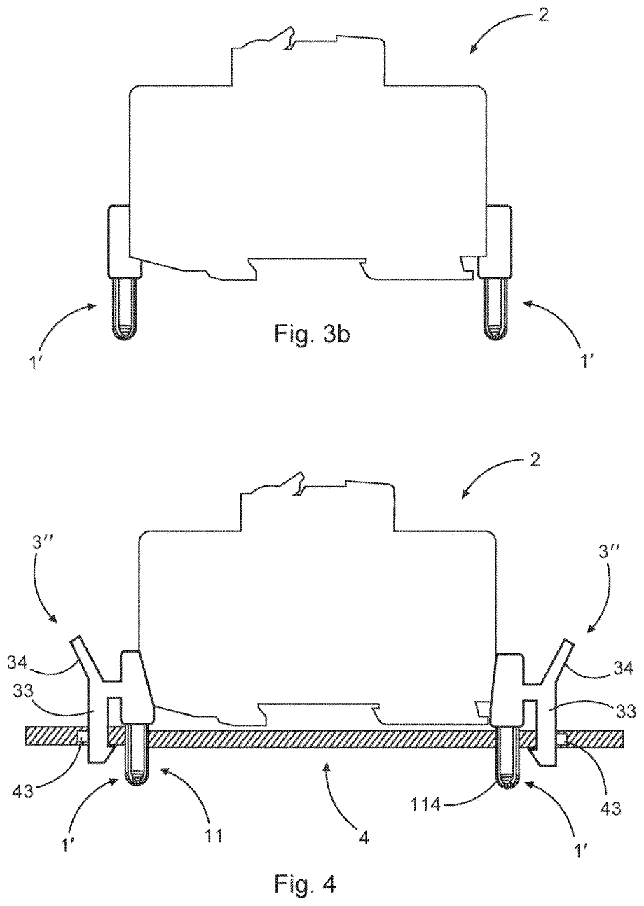

FIG. 3a shows a circuit breaker 2 in the form of a so-called “black box”, i.e., without showing its operating principle. In the drawing, this has an electrical terminal, not described in greater detail, on the right and left—i.e., on two opposite sides. The angled pin contact 1′ to be connected to it is arranged at each of these terminals.

FIG. 3b shows the circuit breaker 2 with the two angled pin contacts 1′ connected to it.

FIG. 4 shows an assembly comprising, for example, the printed circuit board 4 known from the prior art—or a comparable printed circuit board—and the circuit breaker 2 attached to it and electrically conductively connected to it. For this purpose, the respective casing 3′ is in each case supplemented by a latching device, which is designed as a latching arm 33, so that it is already a contact carrier 3″. In this way, each of the two angled pin contacts 1′ has its own separate contact carrier 3″, which can be latched to the printed circuit board 4 with its respective latching arm 33. Together, the two contact carriers 3″ can fasten themselves, the angled pin contact 1′ held in each of them and thus the circuit breaker 2 to the printed circuit board 4. A lever arm 34 is formed on each latching arm 33 for releasing. By pressing the two lever arms 34 together, the two latching arms 33 shown pivot apart to disengage and the circuit breaker 2 can be released from the printed circuit board 4.

The angled pin contacts 1′ are each inserted with their respective plug-in region 11 through a through-contact opening 41 of the printed circuit board 4 and make electrical contact with the contact material of the electrically conductive inner coating of this through-contact opening 41. This contact material belongs to the conductor frames of a circuit of the printed circuit board 4 that is to be optionally interrupted or also electrically conductively connected by the circuit breaker 2.

When the plug-in region 11 of the respective pin contact 1′ is plugged into the respective through-contact opening 41 of the printed circuit board 4, the plug-in segments 114, which are conical on the outside at their ends, move slightly towards each other, which is favored by the sufficiently elastic, metallic material of the pin contacts 1′. Ideally, their outer surfaces, which are slightly directed outwards when not mated, are aligned parallel to the mating axis and thus to the plug-in direction. This is done by applying a corresponding outwardly acting counterforce, through which they make electrically conductive contact with the contact material arranged in the through-contact opening 41 of the printed circuit board 4 with the largest possible common contact area, ideally in parallel alignment. The contact material preferably belongs to a conductor track of the circuit of the printed circuit board 4 and/or it is at least electrically conductively connected to the conductor track. This enables particularly high currents to be transmitted between the circuit breaker 2 and the printed circuit board 4 in the operating state with very little manual and design effort. These pin contacts 1′ only need to be connected to the circuit breaker 2—which can otherwise also be used in the control cabinet or similar—and inserted together into the through-contact openings 41 of the printed circuit board 4, while the latching arms 33 of the pin contacts 1′ latch into the latching recesses 43 of the printed circuit board 4. By pressing the two lever arms 34 of the two contact carriers 3″ shown together, this latching can—as already mentioned—be released again, i.e., unlatched, and the circuit breaker 2 can be removed from the printed circuit board 4.

The circuit breaker 2 is thus both mechanically fastened to the printed circuit board 4 and electrically conductively connected to and disconnected from it in a very simple and inexpensive manner. It is also particularly important that this electrically conductive connection has a particularly high current-carrying capacity due to the outer contour of the plug-in segments 114, which fits perfectly into the shape of the through-contact opening 41.

### LIST OF REFERENCE SIGNS

1 pin contact
1′ angled pin contact
11 plug-in region
114 plug-in segment
140 slots
18 terminal region of angled connection portion
2 circuit breaker
3, 3′, 3″ contact carrier, casing
33 latching arm/lever arm
4 printed circuit board
41 through-contact opening
43 latching recess
α connection angle

1. A connector assembly for installing a printed circuit board of a circuit breaker, wherein the connector assembly has at least the following:
at least two pin contacts each angled by a connection angle (α), wherein each of the pin contacts is formed in one piece from metal:
a terminal-side terminal region for electrically conductive connection to the circuit breaker,
a plug-in-side plug-in region for plugging into a through-contact opening of a printed circuit board,
wherein the plug-in region has the following:
a circular cross-section,
a plug-in axis running in the plug-in direction and
at least two slots crossing each other in the plug-in axis, whereby
at least four plug-in segments pointing in the plug-in direction and each having a circular-segment-like outer contour are formed in the plug-in region of the respective pin contact, and
a connection portion that connects the plug-in region to the terminal region and is angled by the connection angle (α).

2. The connector assembly as claimed in claim 1, wherein the connection angle (α) is greater than 85° and less than 95°.

3. The connector assembly as claimed in claim 1, wherein the connection angle (α) is a right angle when idealized.

4. The connector assembly as claimed in claim 1, wherein the slots end either in the plug-in region or at the latest in the connection portion.

5. The connector assembly as claimed in claim 1, wherein each pin contact is formed from a material that is at least slightly reversibly deformable.

6. The connector assembly as claimed in claim 1, wherein the pin contact is a rotary part, at least in portions.

7. The connector assembly as claimed in claim 1, wherein the slots are formed in the plug-in region by sawing or milling.

8. The connector assembly as claimed in claim 1, wherein the plug-in region is embodied symmetrically, and wherein the pin axis is, at least in some regions, an axis of symmetry of the plug-in region.

9. The connector assembly as claimed in claim 1, wherein the diameter of the plug-in region increases at least slightly towards a plug-in-side end of the pin contact in the unplugged state.

10. The connector assembly as claimed in claim 1, wherein the connection portion is surrounded by an electrically insulating material at least in the region of the connection angle (α).

11. The connector assembly as claimed in claim 1, wherein the connector assembly has, for each of the pin contacts, an electrically insulating contact carrier, which surrounds the respective pin contact at least in the region of its connection angle (α).

12. The connector assembly as claimed in claim 11, wherein the contact carrier has a latching device for fastening the pin contact to the printed circuit board.

13. A system formed of a connector assembly as claimed in claim 1 and a printed circuit board and a circuit breaker, wherein the printed circuit board has a circuit which has at least one conductor track and is electrically conductively connected to at least two circular through-contact openings, wherein the circuit breaker has a mechanical disconnector with at least two terminals which are optionally configured to be electrically disconnectable and electrically connectable by the switch, wherein one of the angled pin contacts is configured to be electrically conductively connected or at least connectable to each of these two terminals on the terminal side and is configured to be inserted or at least insertable into said through-contact opening on the plug-in side and thus is configured to be electrically conductively connected or at least connectable to the circuit.

14. The system as claimed in claim 13, wherein the connector assembly is configured to be latchable to latching recesses of the printed circuit board.

15. The connector assembly as claimed in claim 2, wherein the connection angle (α) is a right angle when idealized.

16. The connector assembly as claimed in claim 2, wherein the slots end either in the plug-in region or at the latest in the connection portion.

17. The connector assembly as claimed in claim 2, wherein each pin contact is formed from a material that is at least slightly reversibly deformable.

18. The connector assembly as claimed in claim 2, wherein the pin contact is a rotary part, at least in portions.

19. The connector assembly as claimed in claim 2, wherein the slots are formed in the plug-in region by sawing or milling.

20. The connector assembly as claimed in claim 2, wherein the plug-in region is embodied symmetrically, and wherein the pin axis is, at least in some regions, an axis of symmetry of the plug-in region.
